(19) United States
(12) Patent Application Publication
(10) Pub. No.: US 2025/0368074 A1
(43) Pub. Date: Dec. 4, 2025

(54) SOLAR CHARGING SYSTEM

(71) Applicant: TOYOTA JIDOSHA KABUSHIKI KAISHA, Toyota-shi (JP)

(72) Inventors: Yukinori MURAKAMI, Toyota-shi (JP); Yuma MIYAMOTO, Miyoshi-shi (JP)

(73) Assignee: TOYOTA JIDOSHA KABUSHIKI KAISHA, Toyota-shi (JP)

(21) Appl. No.: 19/036,520

(22) Filed: Jan. 24, 2025

(30) Foreign Application Priority Data
May 30, 2024 (JP) 2024-087649

(51) Int. Cl. B60L 53/51; B60L 53/63; H02J 7/35; H02S 20/30

(52) U.S. Cl. CPC B60L 53/51; B60L 53/63; H02J 7/35; H02S 20/30

(57) ABSTRACT

A solar charging system mounted on a vehicle, comprising: a solar panel; an auxiliary battery; a high-voltage battery; and a control unit that controls switching between a first charging state for charging the generated power of the solar panel to the auxiliary battery and a second charging state for charging the generated power of the solar panel to the high-voltage battery, wherein the control unit controls the average power generation amount of the solar panel in a predetermined past period to the first charging state when the average power generation amount of the solar panel is equal to or less than a predetermined threshold value, and controls the second charging state when the average power generation amount of the solar panel exceeds the predetermined threshold value.

### CROSS-REFERENCE TO RELATED APPLICATION

This application claims priority to Japanese Patent Application No. 2024-087649 filed on May 30, 2024, incorporated herein by reference in its entirety.

### BACKGROUND

### 1. Technical Field

The present disclosure relates to a solar charging system that controls supply of power that is generated by a solar panel that is mounted on a vehicle.

### 2. Description of Related Art

Japanese Unexamined Patent Application Publication No. 2019-050713 (JP 2019-050713 A) discloses a solar charging system in which a first mode and a second mode are switched based on at least power that is generated by a solar panel. In the first mode, processing of charging an auxiliary battery with the power that is generated by the solar panel, and processing of indirectly charging a high-voltage battery with the power that is accumulated in the auxiliary battery, are repeatedly performed in accordance with amount of power stored in the auxiliary battery. In the second mode, the high-voltage battery is directly charged with the power that is generated by the solar panel.

### SUMMARY

In the solar charging system described in JP 2019-050713 A, when the power that is generated by the solar panel fluctuates up and down across a threshold value due to effects of the state of solar irradiance or the like, switching between the first mode and the second mode frequently occurs. Such frequent switching of modes (states of charge) is undesirable, since deterioration of the auxiliary battery advances, the load on components necessary for switching of the modes increases, and so forth.

The present disclosure has been made in view of the above problem, and an object thereof is to provide a solar charging system that is capable of suppressing advance in deterioration of an auxiliary battery and reducing a load on components necessary for switching a charging state.

In order to solve the above issue, an aspect of the technique of the present disclosure is
a solar charging system that is installed in a vehicle, the solar charging system including
a solar panel,
an auxiliary battery,
a high-voltage battery, and
a control unit for controlling switching between a first charging state in which the auxiliary battery is charged with power that is generated by the solar panel, and a second charging state in which the high-voltage battery is charged with power that is generated by the solar panel, in which
the control unit performs control to the first charging state when an average power generation amount of the solar panel in a predetermined period in the past is no greater than a predetermined threshold value, and performs control to the second charging state when the average power generation amount exceeds the threshold value.

According to the solar charging system of the present disclosure, the switching of the charging state is determined by an average value, rather than an instantaneous value of the power generation amount of the solar panel, and accordingly advance in deterioration of the auxiliary battery can be suppressed, and the load on the components necessary for switching the charging state can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a solar charging system according to an embodiment of the present disclosure;

FIG. 2 is a processing flowchart of charge control (standard) executed by the solar charging system;

FIG. 3 is a processing flowchart of charge control (application) executed by the solar charging system;

FIG. 4 is a diagram for explaining a power path when charging an auxiliary battery; and

FIG. 5 is a diagram for explaining a power path when charging a high-voltage battery.

### DETAILED DESCRIPTION OF EMBODIMENTS

In the solar charging system according to the present disclosure, the state in which the generated power of the solar panel is charged to the auxiliary battery is set as a standard, and the control is performed to switch the generated power of the solar panel to the state in which the high-voltage battery is charged only when the average power generation amount in a predetermined period in the past exceeds a reference value. As a result, it is possible to suppress a phenomenon in which the charging state is frequently switched due to the influence of solar radiation or the like, and thus it is possible to suppress the deterioration progress of the auxiliary battery and to reduce the load on the components necessary for switching the charging state.

Hereinafter, an embodiment of the present disclosure will be described in detail with reference to the drawings.

### Embodiment

### Configuration

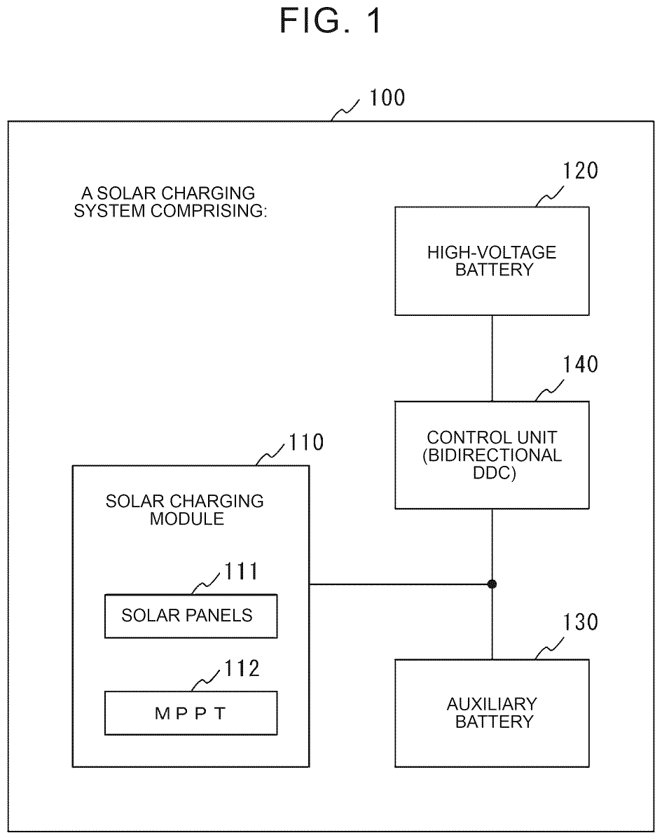

FIG. 1 is a block diagram illustrating a schematic configuration of a solar charging system 100 according to an embodiment of the present disclosure. The solar charging system 100 illustrated in FIG. 1 includes a solar power generation module 110, a high-voltage battery 120, an auxiliary battery 130, and a control unit 140.

The solar charging system 100 may be mounted on vehicles such as hybrid electric vehicle (HEV), plug-in hybrid electric vehicle (PHEV), and battery electric vehicle (BEV), for example.

The solar power generation module 110 is a power generation device that generates electric power by being irradiated with sunlight, and outputs the generated electric power to the auxiliary battery 130 and the control unit 140 connected to the solar power generation module 110. The solar power generation module 110 includes a solar panel 111 that is an aggregate of solar cells, and a MPPT 112 that controls the generated power of the solar panel 111 in a maximum-power-point tracking manner. The generated electric power of the solar panel 111 is calculated from a measurement value of a sensor or a measuring instrument (not shown).

The high-voltage battery 120 is a secondary battery configured to be chargeable and dischargeable, such as a lithium ion battery. The high-voltage battery 120 is connected to a main device (not shown) for driving the vehicle, and can supply power necessary for the operation of the main device. The high-voltage battery 120 is connected to the solar power generation module 110 via the control unit 140 so as to be able to be charged by electric power generated in the solar panel 111 of the solar power generation module 110. The high-voltage battery 120 is connected to the auxiliary battery 130 via the control unit 140 so that the electric power stored by itself can be supplied to the auxiliary battery 130 and can be charged by the electric power stored in the auxiliary battery 130. The high-voltage battery 120 is, for example, a driving battery having a rated voltage higher than that of the auxiliary battery 130.

The auxiliary battery 130 is a secondary battery configured to be chargeable and dischargeable, such as a lithium-ion battery or a lead-acid battery. The auxiliary battery 130 is connected to an auxiliary device (not shown) other than the main device described above, and can supply power necessary for the operation of the auxiliary device. The auxiliary battery 130 is connected to the solar power generation module 110 so as to be able to be charged by electric power generated in the solar panel 111 of the solar power generation module 110. The auxiliary battery 130 is connected to the high-voltage battery 120 via the control unit 140 so as to be able to be charged by the electric power stored in the high-voltage battery 120 and to be able to supply the electric power stored by itself to the high-voltage battery 120. The amount of electricity stored in the auxiliary battery 130, the input/output current, and the like are monitored by a sensor, a measuring instrument, and the like, which are not shown.

The control unit 140 is a bidirectional power converter capable of converting input power into power of a predetermined voltage and outputting the converted power, and is typically configured as an electronic control unit including a bidirectional DCDC converter (bidirectional DDC). The control unit 140 has one end (primary side) connected to the solar power generation module 110 and the auxiliary battery 130, and the other end (secondary side) connected to the high-voltage battery 120. The control unit 140 may supply (pump-charge) electric power output from the solar power generation module 110 and the auxiliary battery 130 connected to one end to the high-voltage battery 120 connected to the other end. At the time of power supply, the control unit 140 performs a boosting operation of boosting the voltage of the electric power input to one end to become the output voltage of the other end. In addition, the control unit 140 can supply (pump-out charge) the electric power of the high-voltage battery 120 connected to the other end to the auxiliary battery 130 connected to the one end. At the time of power supply, the control unit 140 performs a step-down operation in which the voltage of the power input to the other end is stepped down to be the output voltage of the one end.

### Control

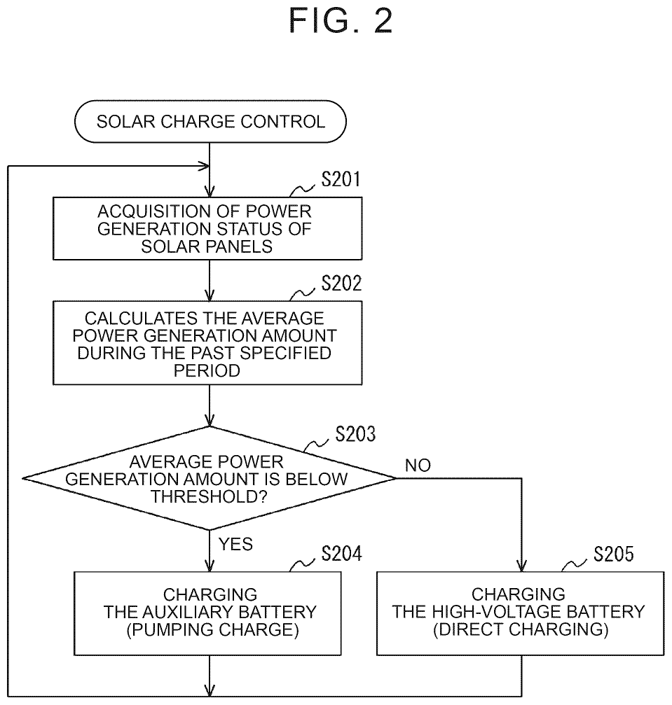

Next, the control performed by the solar charging system 100 according to the present embodiment will be described with reference to FIG. 2 to FIG. 5.

### Standard Control

FIG. 2 is a flowchart for describing a standard solar charging control procedure executed by the solar charging system 100. The standard solar charging control illustrated in FIG. 2 is repeatedly performed during a period in which the solar charging system 100 is operating.

### S201

The solar charging system 100 acquires the power generation state of the solar panel 111 in the solar power generation module 110. The power generation state of the solar panel 111 can be exemplified by the amount of electric power generated by the solar panel 111 per predetermined unit time (hereinafter referred to as “power generation amount of the solar panel 111”). The power generation amount of the solar panel 111 acquired by the solar charging system 100 is stored and accumulated in a predetermined memory (not shown) or the like. When the solar charging system 100 acquires the power generation amount of the solar panel 111, the process proceeds to S201.

### S202

The solar charging system 100 calculates an average power generation amount of the solar panel 111 in a predetermined period in the past. The average power generation amount can be obtained by averaging the power generation amount of the solar panel 111 in a predetermined period in the past. The past predetermined time period is a time period from the current time point at which the calculation is performed to a predetermined time (for example, 10 minutes, 30 minutes, 1 hour, or the like). In a case where the average power generation amount cannot be calculated (such as an initial state immediately after the start of control), the solar charging system 100 waits for the calculation of the average power generation amount until the past power generation amount of the solar panel 111 necessary for the calculation can be acquired. When the solar charging system 100 calculates the mean power generation amount of the solar panel 111, the process proceeds to S202.

### S203

The solar charging system 100 determines whether the average power generation amount of the solar panel 111 is equal to or less than a predetermined threshold value. This determination is made in order to determine an appropriate charging destination (supply destination) of the generated power of the solar panel 111. The predetermined threshold value is set to a value indicating that the solar panel 111 is generating a large amount of electric power (or a large amount of electric power) that can be supplied to the high-voltage battery 120. If the solar charging system 100 determines that the averaged power generation amount of the solar panel 111 is less than or equal to the threshold (S203, Yes), the process proceeds to S204. On the other hand, if the solar charging system 100 determines that the averaged power generation amount of the solar panel 111 exceeds the threshold (S203, No), the process proceeds to S205.

### S204

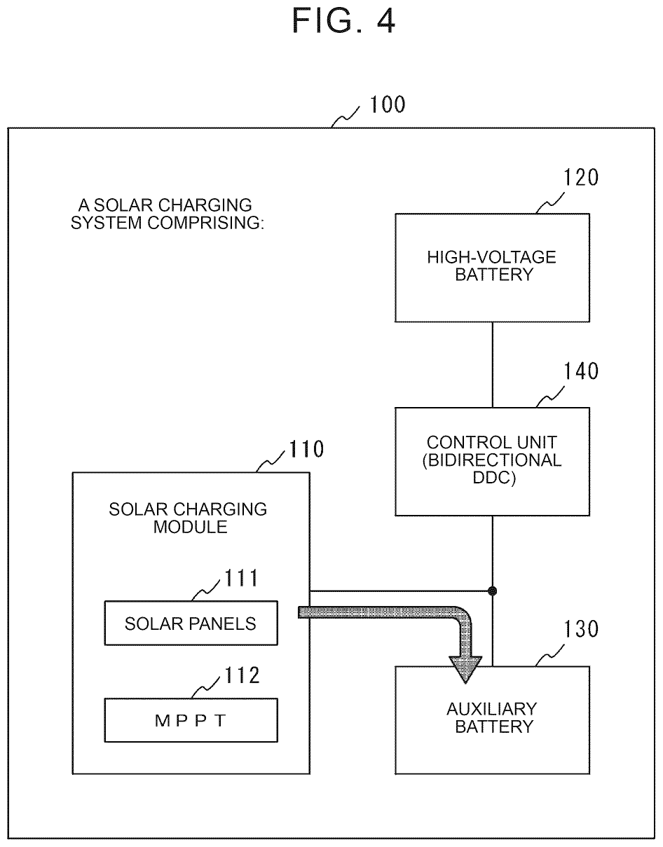

The solar charging system 100 performs control of supplying electric power from the solar power generation module 110 to the auxiliary battery 130 to charge the auxiliary battery 130 (first charging state). In this first state-of-charge, as shown in FIG. 4, the solar charging system 100 does not activate the control unit 140 (bi-directional DDC) in principle. When the high-voltage battery 120 is charged with the electric power of the auxiliary battery 130 (pumping charge), the control unit 140 (bidirectional DDC) is activated. When the solar charging system 100 performs control to charge the auxiliary battery 130, the process proceeds to S201.

### S205

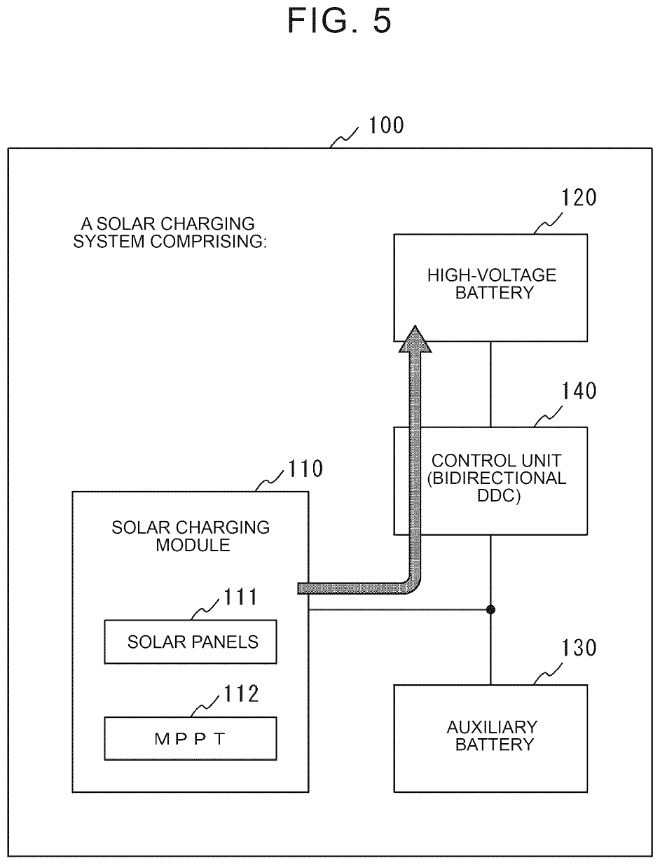

The solar charging system 100 performs control of supplying electric power from the solar power generation module 110 to the high-voltage battery 120 to charge the high-voltage battery 120 (second charging state). In this second state-of-charge, as shown in FIG. 5, the solar charging system 100 activates the control unit 140 (bi-directional DDC). As a result, the high-voltage battery 120 is directly charged by the power generated by the solar panel 111 without passing through the auxiliary battery 130. Once the solar charging system 100 implements control to charge the high-voltage battery 120, the process proceeds to S201.

### Application Control

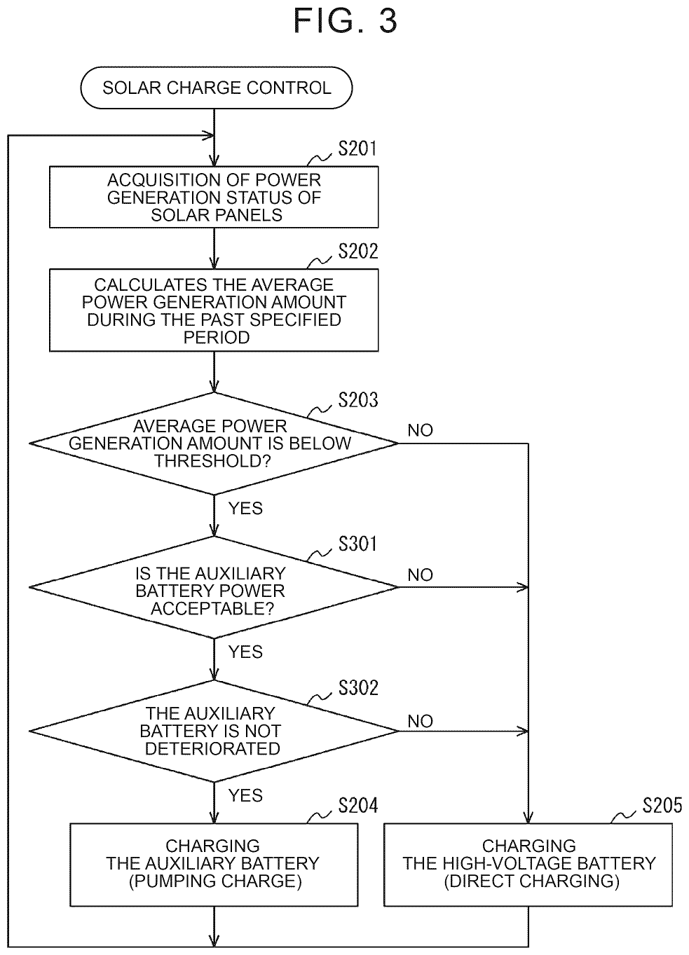

FIG. 3 is a flowchart for describing a procedure of an application solar charging control executed by the solar charging system 100. The exemplary solar charge control illustrated in FIG. 3 is repeatedly performed during a period in which the solar charging system 100 is operating.

This adaptive solar charge control is the addition of S301 and S302 treatment between S203 and S204 of the standard solar charge control described above (FIG. 2). Hereinafter, a process that differs from the standardized solar charge control in the applied solar charge control will be described by replacing S301 in which the process proceeds when the averaged power generation amount of the solar panel 111 is equal to or less than the threshold (S203, Yes).

### S301

The solar charging system 100 determines whether the auxiliary battery 130 is capable of accepting power. This determination is made in order to ascertain whether or not the auxiliary battery 130 is in a chargeable state. As an example, when the amount of electric power stored in the auxiliary battery 130 is smaller than a predetermined value (fully charged state), it is determined that electric power can be accepted. In addition, when an abnormality such as the temperature of the auxiliary battery 130 being higher than a predetermined value is recognized, it is determined that the electric power cannot be accepted. Further, when the input/output power is limited to prevent the deterioration of the auxiliary battery 130, it is determined that the input/output power is acceptable/unacceptable in accordance with the limited power. The state of the auxiliary battery 130 is determined based on a physical quantity or the like detected by a sensor, a measuring instrument, or the like. If the solar charging system 100 determines that the auxiliary battery 130 is capable of accepting power (S301, Yes), the process proceeds to S302. On the other hand, if the solar charging system 100 determines that the auxiliary battery 130 is unable to accept power (S301, no), the process proceeds to S205.

### S302

The solar charging system 100 determines whether the auxiliary battery 130 is not in a degraded state. The deterioration state refers to a state in which the auxiliary battery 130 can be estimated to be deteriorated, such as a state in which the full charge capacity of the auxiliary battery 130 is extremely small or a state in which the internal resistance of the auxiliary battery 130 is out of the reference value. If the solar charging system 100 determines that the auxiliary battery 130 is not degraded (S302, Yes), the process proceeds to S204. On the other hand, if the solar charging system 100 determines that the auxiliary battery 130 is degraded (S302, No), the process proceeds to S205.

### Operations and Effects

As described above, in the solar charging system 100 according to the embodiment of the present disclosure, when the average power generation amount of the solar panel 111 in the past predetermined period is equal to or less than the predetermined threshold value, the auxiliary battery 130 is charged with the generated power of the solar panel 111. The solar charging system 100 performs control to directly charge the high-voltage battery 120 with the generated electric power of the solar panel 111 without passing through the auxiliary battery 130 when the average power generation amount of the solar panel 111 in a predetermined period in the past exceeds a predetermined threshold value.

According to this control, since the switching of the charging state (charging destination) is determined not by the instantaneous value of the power generation amount of the solar panel 111 but by the average value of the predetermined period, it is possible to avoid frequent occurrence of switching of the charging state due to sudden change in solar radiation or the like. Therefore, the progress of deterioration of the auxiliary battery 130 can be suppressed, and the load of a component (for example, a relay inserted between the control unit 140 and the high-voltage battery 120) necessary for switching the charging state can be reduced.

Although an embodiment of the present disclosure has been described above, the present disclosure can be regarded as not only a solar charging system but also a solar charging control method, a program of the method, a computer-readable non-transitory storage medium storing the program, a vehicle including the solar charging system, and the like.

The solar charging system of the present disclosure can be used in a vehicle or the like on which a solar panel is mounted.

What is claimed is:

1. A solar charging system that is installed in a vehicle, the solar charging system comprising:
a solar panel;
an auxiliary battery;
a high-voltage battery; and
a control unit for controlling switching between a first charging state in which the auxiliary battery is charged with power that is generated by the solar panel, and a second charging state in which the high-voltage battery is charged with power that is generated by the solar panel, wherein the control unit performs control to the first charging state when an average power generation amount of the solar panel in a predetermined period in the past is no greater than a predetermined threshold value, and performs control to the second charging state when the average power generation amount exceeds the predetermined threshold value.

2. The solar charging system according to claim 1, wherein the control unit performs control to the second charging state when the auxiliary battery is unable to accept power, even when the average power generation amount of the solar panel in the predetermined period in the past is no greater than the predetermined threshold value.

3. The solar charging system according to claim 1, wherein the control unit performs control to the second charging state when the auxiliary battery is in a predetermined state of deterioration, even when the average power generation amount of the solar panel in the predetermined period in the past is no greater than the predetermined threshold value.
